(19) United States
(12) Patent Application Publication
(10) Pub. No.: US 2004/0163289 A1
(43) Pub. Date: Aug. 26, 2004

(54) Automobile for sale sign

(76) Inventor: David Andrew Pearson, Hungtington Beach, CA (US)

Correspondence Address: David Pearson, 22102 Cape May Lane, Huntington Beach, CA, 92646, US

(21) Appl. No.: 10/372,611

(22) Filed: Feb. 25, 2003

(51) Int. Cl. G09F 7/00

(52) U.S. Cl. 40/584

(57) ABSTRACT

A sign for cars to sell different items as an alternative to paying for a newspaper classified ad. The use of newspaper classified ads to sell percentages of and to protect ideas.

### FIELD

Advertising; this invention relates to newspaper classified advertising.

### SUMMARY

For sale sign for using automobiles etc. to sell different items. Classified ad to sell all or part of ideas.

### BRIEF DESCRIPTION OF THE DRAWING

FIGS. 1 and 2 are front views.

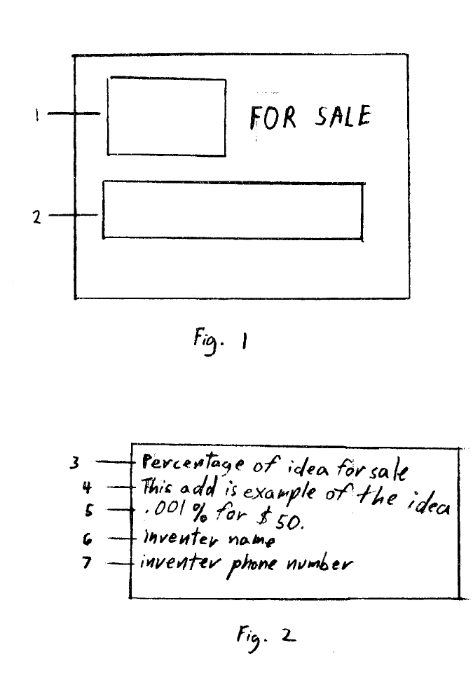

### DETAILED DESCRIPTIONS OF THE DRAWINGS

Figure one is an illustration of a for sale sign. It can be a sign of conventional for sale sign construction with the illustrated re-arrangemnt of criteria. Figure two is an illustration of a newspaper classified ad. Criteria in the ad is subject to change.

1. Identification box can be a white rectangle (of increased size) such as those normaly found on for sale signs. The item/service etc. that is to be offered can be erasably written in: “TV” is an example.

2. Descrption box can be a white rectangle such as those normaly found on for sale signs. Such information as; description of the item for sale, price and the seller can be erasably written in it. An example is; 25 inch color tv $100. “name of seller” “phone number of seller”.

3. Advertisment description can be a description of what is being sold. The use of classified ads to (attempt to) sell percentages of ideas; idea marketing, is the concept. Running such an ad can also protect an idea (save copy of ad).

4. Description can be a description of the idea, uspto #s can be included. A name for the invention can be included.

5. Offer can be any offer the attempts to generate revenue from an idea. It is expected that for different types of offers the criteria of the ad would change.

6. Inventer name can be the name of the inventor. Further description can be included.

7. Inventer phone number can be the phone number of the inventer.

The for sale sign can be used for the idea marketing concept. Alternatives and bussiness applications come to mind as a result of being presented with the idea marketing concept: Onr example is the use of prefabricated legal contracts by the advertisers; newspapers etc. Anther example is offering for the take over of an idea for a predetermined amount of time for a percentage of the profits. It is contended that all such notions are obvious.

Related to (aspects of) the concepts are items from the following list of predictions: Video book improvment; dvd or other electronic media form contains contents of a book or other printed material (not excluding pictures etc.) for reading on a tv set etc. An example of the (remote control) electronic device for reading the book displays the words (of adjustable size lettering) one or more lines of adjusable size (one or more charactors) at a time on a video display (a tv set) (along with a switchable numeric display for words per minute). The lines would be manually or automaticly scrolled (with the remote control). The rate at which they are automaticly scrolled can be adjusted. Corresponding circuitry can be built-in to electronic equipement, dvd players for instance. Programs and equipement for reading in such a manner on a computer are also predicted. Software and video books to teach speed reading and the described modifications for handheld video books are also predicted. Also included in the list: Happy face (or other image) uhf loop, clamp-on/bolt-on/built-in video game controller apparatus for recliner chair (modified to accept the equipement) or other furniture, device/hair dryer stand for drying pet feces or other downwards applications, spacer to adapt skateboard trucks to accept rollerblade (or other) wheels, power fan with the “sports” (or team name/colors etc.) on it, visual/audio effects for power fans, fake potato with glasses, cooking (steam/fry) basket with foldable/removable legs, book or card showing pictures (and descriptions/habitat) of dangerous spiders and (such) information/pictures about (other) dangerous (looking) living things, strap-on adaptor holder, insolated butter compartment that uses adjustable sliding insolation and a refrigerater wall thin spot to adjust temperature (uspto Ser. No. 09/455,256). Also included in the list; firework candle (a sparkler next to the wick to cause the emission of sparks while the candle is burning), areodynamic bodyboard leash plug, liquid soap/shampoo injected shower nozzle, glow key(hole) parts, (opposing) spools attached to motor as artificial muscle, glow buttons/switches (for all types of equipement), switch for toilet to stop the flow of water, toilet paper holder with handled rod that inserts externaly (fake handle on opposite side makes holder look symetrical), switch to disconnect cordless phone base unit antenna, (bigger) magnifiing glass on solar panel. Also included in the list; (aloft) garage sale ballon (as remote sign) (balloon in the shape of the letters), shower handle with protrusion, chair/furnature with (drainable/removable) ice compartment, water heater (with) tap (for emergencies), bar report, bike light with pop-out (telescoping) rear-view mirror (fake handle) (uspto Ser. No. 10/291,257), diet scale, smaller full scale reading, dial completes multiple rotations to reach full scale reading, pickup truck triangle; situated infront of tailgate to reduce drag (and act like trunk) (lockable) (mechanical means to bolt it in) (cushioned external pads extend from inside of it for instance) (shape is subject to change). Also included in the list: Pull-out barbeque ignition switch; moves the ignitor out of flame after ignition, (internal) (flashing) ringer light; (for clear/translucent phones); flashes when phone rings, forked axle skateboard truck, AC motor starter (uses discharge circuit), tube to extend automobile air conditioning outlet, foldable telescoping tv stand [(doubles as antenna) for small tv sets], phone etc. with switch to disconnect battery, devices (toothbrush) designed to use phone batteries, (glow) (light) switch cover. Also included in the list: car battery light (bolts directly onto battery), food dehydrator that uses lights (one sided mirrored internal walls etc.).

Also included in the list: Windowsill fireplace; a (portable) fireplace etc. designed to be placed under the windowsill [new window screen supports (flexible) exhaust tube] (screen is ordered from manufacturer) (or comes with complete kit), wind-up/power (stand alone) rotisserie (removable) for ovens etc., (phone) kit to add battery switch, (thick) (internal) (clear) (colored) refrigerator insolation drapes (for household refrigerators), colored display sticker (to change or enhance color of display) retractable/telescoping lighter. Also included in the list: The use of advertising to (attempt to) generate revenue directly from and to protect ideas (uspto Ser. No. 10/109,200), sales of vouchers for hypothetical products (at reduced prices); the buyer of the voucher gets the product at reduced price if it reaches the manufacturing stage, bussiness monopoly, bussiness/shopping section as alternate route in monopoly or other board game, external refrigerator magnet with thermometer etc., internal (magnetic) refrigerator etc. thermometer etc. (highlighted at freezing point etc.) table/desk with pull-out (retractable) (movable) (slidable) typewriter etc. platform.

Also included in the list: Cue chaulk drill bit, motorized cue chalk applicator, camcorder with phone jack [for video phone (tv set)] bean bag drink holder (for cars), razor with spring activated (hinged) (roller) lubricator (in front of blade), (portable) (wheeled) large/meduim scale misting machine (for resorts), shower mirror with flexible armature that connects to drape rod. Also included in list: (Shakespearian/jive etc.) language translater book with instructions to memorize one more words per day etc. and keyword list, bbq with built-in light, stovetop bbq; has overhead vent to safely send smoke etc. to existing stove vent, electric vehicle get energy refills by swapping batteries at stations; the vehicles are sold with used batteries or without batteries (voucher for used battery from gas station included) (concept, buyer does not have to part with new batteries to get refill) [instructions/list of participating refill (gas) stations included].

Also included in the list: Removable handlebar devices and retractable (telescoping light/mirror) handlebar devices (uspto #09/451,020/10/291,251) (concealable devices include conventional handlebar cap), scoby snacks (for people/animals). Also included in the list: Steak sandwich patties for supermarkets, generic as a (substitute) brand name; an example of a subtitute brand name is “generic y” in which y can be any brand name not excluding generic etc., glow compass, bbq corndog (cart) wiener is first barbequed before batter dip, certified uspto searches, programmable area code (dialer) button (four charactors; 1+area code) for phones, power recliner (chair), clamp-on rods to increase size of existing antennas, antenna repeaters (for a network of broadcast tv/radio) (increase number of broadcast channels/stations so that no two are the same), Also included in the list: Audio/video device signal wires use power cord and ground plug; power strip rewired ground plugs used to connect all signal wire through power strip, disk and tape machine/player that copies entire disk to tape; cd to cassette for instance, (sideways) washer acts as dryer after washing, ac/dc (slot) car set; one car picks up ac voltage in track the other uses dc voltage; enough lines in track so that both cars work from any (forward) position on track, food guide; chlorestoral etc., web site that gathers/transmits opinions about movies.

Also included in the list: Tethered football (elastic tether) (for pass/kick practice), ball attached to spring (for kicking), (cooked) (seasoned) (“gourmet”) canned vegitables, floating duster, rotissorie fish basket, cart etc. with surround/side shock absorbers etc., powerpuff etc. (starts to) grow up etc., drill with detachable motor/battery unit; unit used for other applications (bbq rotissorie, for instance), doll gets a tan, “Barbie's” sister etc. (a doll), (“Barbie”) etc. shampoo for dolls “Barbie” etc. shampoo for people, backyard rollor coaster, (backyard) water slide or (water coaster) (reduced slope) (empties into compatible inflatable pool), large scale water coaster. Also included in the list: Stand-up slip and slide (uses a board), grape squeezer, “Barbie” etc. cosmetics (for people or dolls), phone with address computer/dialer, phone with pop-out (erasable) list, camera calender [a small (detachable) (battery) powered electronic calender with switchable (diode) display that is placed in the field of view of a photograph to display the date in the photograph (uspto Ser. No. 29/174,155), (diamond shape piece of glass on it, etc.), camera case with pouch for a camera calender. Also included in the list: Water bottle with wide or funnel shaped top, table (of adjustable heigth) with slidable (retractable) (removable) (turnable) (etc.) platform etc., sledgehammer can recycler, for sale sign (for automobiles) to sell different things; looks like for sale sign but does not have the words “for sale” on it or; has a (big) space to write in what is for sale then says “for sale” next line(s) have space for descrptions etc., skateboard with one or more than two trucks, spark plug switch; wired to passenger compartment disables cylinder(s) to increase milage, green colored lantern.

Also included in the list: Beach chair etc. with drink holder, stand alone telescoping drink holder, pump or wind-up skateboard etc., bodyboard with inflatable compartment, attachment or part, collapsable (accordian) cabonated beverage (or other liquid) bottle (to preserve carbonation), “start a bussiness” game, (screw)driver holding bit, disposible razor with designer handle, (foam rubber) razer grip, designer holder/handle for (disposable) razors, container/bag for compactor for can recycling, patties with vegitable/fruit as extra ingredients, car with easy access oil filter. Also included in the list: The electric car battery swap energy refill method as it applies to hybrids, glow (bike) gear indicator, diet/light wine, (halloween) candy that looks like rocks, bike light with lighted compass, bike light that lights gear indictor, battery/gas tank for motorized bike that fits in water bottle holder (looks like water bottle), fake microphone (for camcorders), iron watch, roman candle (safety) grip, bike brake/gear shift lever grip, bike seat with built-in pouch, fiberglass etc. watch, bike phone holder, ridged trash bag, casino name; “The 49'r”. Also included in the list: pda joystick, tube that takes D size batteries (for instance) and uses charge-up circuit to start car, basketball backboard board (for ball return), mini dumptser, semi-bouyant swim trainer, telescopic swim goggles, swim goggles with angled side mirror (for side/rear view), a projectile (arrow) launching tube (piece of rubber attached from outside of tube lauches the projectile) (precision fit between tube and projectile).

Also included in the list: Names for pizza (restraunts, brand names etc.); “pizza stand”, “pizza hat” (box has picture of subject wearing hat with a pizza sized platform with a pizza on it, “pizza boy”, “leaning tower”. (Decorative) bricks [(with) brick laying etc. instructioins/instructional video], (tethered) plastic golf ball (with stop net), leverage mountain climbing grip (looks like handlebar grip), trash container with step-on lever that elevates bag (holder) (makes bag replacments easier) [can be designed so that elevated bag (holder) retains (elevated) position until lever is stepped on (pushed) a second time], (elestic) tethered baseball etc. (for pitching practice), container that (controllably) can inject liquid into fuel line, dried ground fruit (for instant fruit juice), double fan, lighted bike gear indicator, glow gear indicator. Also included in the list: Letterbox box (letterbox circuit built into video equipement) [(letterbox) of adjustable size/shape)], insulated duffel bag etc. (allows unit to double as an ice chest), fishing rod with lighted/glow handle, fishing reel with numbered drag adjustment (dial/lever) (the numbers correspond to drag setting in pounds), flexible hook sneller, front reflector with built-in light (like tail light that doubles as reflector), glow grips, bike seat with built-in tail light/reflector etc., bike seat with built in pouch or rigid container, per call billing method for wireless phones (without monthly charges etc.), cycle etc. clock etc. Also included in the list: foot message shower mat, wine bottle lamp, soldering instrument with (solder/flux) dispencer(s), cd frisbee etc., cycle etc.gps etc., bbq stand (bbq corndogs), “wild west” as brand name (for whiskey), wide (wheeled) etc. hoop net, popcorn kernal container with serving dispencer, property stock, motorized [automatic/remote (control) (shut-off)] stroller, motorized scouring pad, hair stylist trainer with pull out hair (and replacable hair modules).

Also included in the list: Vice/robo grip bit, motorized ice chest [with automatic/remote (control) (shut-off)], inflatable (suitcase) chair, controllable/automatic exhaust pipe iris diaphragm/feul line iris diaphragm, motor input iris diaphragm, motor output iris diaphragm, car battery holder battery rightside up terminals at bottom connect to battery terminals for electric car battery swap method; built electric car to accept the holders, “caribean” as a brand name (for rum), magnifing glass lense on infra-red senser/transmitter, (infra-red) remote control with (built-in) (flashlight) (mirror to enhance signal). Also included in the list: Soft (rubber) headboard.

Also included in the list: Tilt solar panel to correspond to lattitude of its location, twine wick candle (extra ingredients for candle wicks to leave glowing residue in the flame), (soft) covers for end of glasses arms, (clip-on) glasses ornaments, cheese shaker/grater device (with detachable grater) (with shaker holes cover) (grater upsidedown at bottom) (turn device upside down for grating), (precious) metal stock etc., green dolfin sticker (uspto Ser. No. 10/291,257), (backyard) wateslide water coaster, wrecking ball toy. Also included in the list: Jigger cap, measuring cup cap, device (module) for cameras containing film and battery, phone sticker for programmed phone numbers, magnifying glass (or lense of different shape for radio antenna, pop-out handlebar devices (uspto Ser. No. 10/291,257) with more than one telescoping member, classified ad; percentage of property for sale, double back up (for computers), automotive fluid tester kit [example; (‘s’ shaped) tube (pipette) takes ten seconds to drain new fluid from the mark, fluid should be changed if it drains in eight seconds) (includes instructions)]. Also included in the list: Circular saw bit, propeller bit (for winding rubberband powered toy airplanes) forked bit (uspto Ser. No. 10/307,570), any bit (related to winding) that can take the place of another machine; example; (hair breading machine); use (bit for) power screwdriver instead, any bit for applications related to cleaning (example; scouring bit), SETI; giant antenna in space (perhaps billions of elements) (device to filter signals from earth), SETI; send out signals also (be able to recieve such sent signals from intersteller distances) send out technical information in hopes of recieving more advanced technical information in return), skate(board) etc. towing motorized (tethered) device.

Also included in the list: Space man (a comic book/movie etc. hero) (looks human) (is an extraterestrial) has advanced equipement (like preditor), a type of personal ad that allows the runner to pay for the services; in an example the ad states what the runner is looking for along with some of his qualifications and uses a reference number. The responder runs an ad in responce using the reference number, the runner inspects the ads looking for the referenced responce. The runner then uses the services (a 900 number) to respond to the reader. Also included in the list: Classified ads that work for a sales percentage, breakaway (plastic) baseball (bat) etc.

Also included in the list: Pineapple/banana express as a name for restraunt/bar, music language book (instructions to memorize a note at a time), fake mustache etc. packaged as gift, face bags (packaged as gift), gift packaging (any item), wet suit clothing, motorized top, designer (cocktail) (glow/flouescent/lighted) straw, coffee brewer with built-in grinder. Also included in the list: (Stick-on) (squeezable) clown nose (with horn) (packaged as gift), clear multilayer cd etc., firework firewood log (tight fit sparkler inserted for instance), sparkler nail (for firework firewood log), (dual position) upside down/rightside up globe, one (group of) elevated antennas to multiple buildings/houses, (swim) goggles with rear/side view angled (45 degree etc.) built-in mirror, keychain container/bottle. Also included in the list: Means to secure ac plug into wall socket examples: (mechanicaly increase distance between prongs) (screw-on hardware such as printer cable hardware), heated ice skate etc. (blade), projectile launching tube [precision fit between the projectlile (stone/arrow etc.) and tube] (elastic unit attached to outside of tube) inside of tube; (smooth) (rifled), razer with light, break-away baseball. Also included in the list: Music language teaching book (instructions to memorize one note etc. at a time), wet suit (material) clothing, motorized top, copies of (famous) (advanced level) chess games, meat from animals that died from natural causes (packaged to convey its origin), soft parts for (pairs of) (eye) glasses, soft covers for parts of (pairs of) (eye) glasses, wide angle showerhead with one or more spin nozzles (and one or more stationary sprayers).

Also included in the list: Wastebasket hoop/backboard (telescoping member for adjustable elevation), sticker to modifiy for sale signs (conforming to the concept described here-in), (fake) (cherry) tomatoe etc. for gun targets, poster etc.; caveman etc. sees edison plant etc., light(bulb) that says “dummy” on it, (neon light etc. that spells “dummy” etc.), toothbrush grip, (glow) (lighted) (skateboard) deck (cover), bubble lamp, bike walkie talkie (holder), keychain (breath/perfume) spray etc. wind pole (rotatable with sail/direction guage for direction and propeller/meter for velocity, fan effects; modification for one or more of the blades including; sparkler holder, (bike tail) light/reflector (holder), mirror spot, marbling (spot), whistle (holder), prism, etc., desk fan with (built-in) light. Also included in the list: Drillchuck wrench bit for expandable applications (squarehead screws for instance) different colors for for sale signs, large tank designed to contain and dispense gasoline etc. residentualy (to use as buffer), (emergency) water boiling sea/contaminated water water retrieval kit (for producing sea salt also), “pure silver” as a brand name (for things containing silver), “silver” as a brand name (for things containing silver), bath robe with hood, (foldable) (rain) water funnel for water bottles (large diameter) decoritive (crystal etc.) apparatus containing platform on bottom, color diffracting (diamond shaped) part on top, [(triangular etc. shaped) rod connects diamond shaped part to platform] (for photographs), color diffracting apparatuses for photographs.

Also included in the list: The following part of the list contains items from bicycle gadgets (uspto Ser. No. 10/291,257): Concealed in handlebar; retractable container, retractable lock, removable devices; lipstick holder, (suntan) lotion holder/container, lighter (holder), match holder, breathsprayer (holder), perfume sprayer (holder), mist ejecter, survival knife (holder), telescope, tire repair kit, pump, wheel lock, alarm, firework (holder) (handlebar grip), lubrication dispencer, removable/retractable concept appied to anything that can fit inside of handlebar,. Also included in the list (items from bicycle gadjets): Bicycle light with flip-out mirror, telescoping member for telescoping mirror doubles as radio antenna for such lights with built-in radios, (glow) (handlebar grips/handlebar caps/brake grips/pedal covers etc., sticker designed for bicycles, reversible front reflector light, lighted front reflector, wireless phone holder, pda holder, sports bottle battery, mist bicycle bottle, bicycle squirt gun, (mineral) water bottle/container with a rock in it, ice adapter with two or more blades to as replacement for front wheel, bicycle bag/cover, waterproof (bicycle) outfit, bicycle clock, bicycle gps, bicycle thermometer, bicycle altimeter, bicycle barometer, bicycle humidity meter, bicycle fitness computer etc., plug-in speaker for concealed handlebar radio, tilt handlebar, bicycle pet trailer/basket, (bicycle) wind turbine (charges battery of electric vehicle), potato head handlebar decoration, potato with glasses as handlebar decoration, bicycle basket with container/water bottle holder wind-up bicycle etc. motor, bicyclist report, bicycle calender, bicycle buyers guide, telescoping lighter, (glow) (color changing) lava light (uses color wheel), timed light for glow apparatus, razer with light, motorcycle (helmet) windshield wiper/washer, ignition lock, glow compass, glow switches for lamps etc., cordless phone base unit antenna switch, antenna ball, broadcast signal processor strengthener, automobile mist ejector, binoculars etc with built-in disperce lazer field of view illuminator, binoculars with removable field of view illuminator(s), bbq with built-in light(s), bbq (with built-in) squirt gun holder, bbq (with built-in) automated douser, bbq (with built-in) drink holder, bbq (with built-in) lighter holder, bbq with built-in drink holder, bbq (with built-in) charcoal lighter fluid dispencer, bbq (with built-in) charcoal lighter fluid container holder, other (built-in) holders for bbq, other (built-in) gadgets etc. for bbq, prism effect candle holder/light/light bulb, hard drive movie storage device/player, perfume name that matches scent; example; “orchid” (etc.) perfume smells like an orchid, model (vehicle) on keychain, prism effect lamps/light bulb cover, prism effect candle container, (seasonal) (scenic) calender/postcard etc. with dated pictures (corresponding to month of year) (and living subjects), bicycle calender, calender/postcard etc. with (dated) pictures of natural phenomina, a sign (for bars) (including one or more humerous pictures) that says; “don't squeeze the bar man” etc., chainsaw meat carver etc., chair with built in (video) projector (tv), shirt with fake chip on it, ice chest with (built-in) light, telescoping binoculars, two or more color wheels for color change (lava) lights, (projector) (voice) (chime) (etc.) clock that projects/voices/chimes (time) at predetermined intervals, holder that stores bottles/containers upsidedown, shower control handle with protrusion, wind up vehicle etc. motor, lazer pointer (in shape of) gun, many supersonic planes fly in eye opposite direction of rotation to (attempt to) stop/reduce hurricane etc., hand held shower nozzle grip, (small) prism on lense of flashlight (uspto Ser. No. 10/096,975).

Also included in the list: The following part of the list includes items from drill bits (uspto Ser. Nos. 10/307,570 10/300,373); bit for winding modified fishing reels (added winding bit recepticle), telescoping drill bit, drink mix/blender bit, handle grip for drills, glow screwdriver, (glow) driver grip, cutlery grip, sportfishing improvment (filet fish right away, bag, then put on ice), glow fishing equipement, royal/super as (tool) brand name.

All bits listed here-in can be for cordless screwdriver etc. It is not guaranteed that references to other patent applications are accurate. It is not gauranteed that any items listed here-in are not in previous (abandoned) patent applications.

1. Any sign for vehicles etc. to take the place of a newspaper classified ad.

2. The use of advertising as a means to (attempt to) generate revenue directly from ideas/inventions

3. Classified ad that advertises to sell all or part of an idea.
